(19) United States
(12) Patent Application Publication
(10) Pub. No.: US 2019/0124900 A1
(43) Pub. Date: May 2, 2019

(54) Fishing Rod Tip Guide

(71) Applicant: George Q. Zhang, Vancouver (CA)

(72) Inventor: George Q. Zhang, Vancouver (CA)

(73) Assignee: V-Mark Enterprises Ltd., Vancouver (CA)

(21) Appl. No.: 15/798,240

(22) Filed: Oct. 30, 2017

(51) Int. Cl. A01K 87/04; B21D 22/02

(52) U.S. Cl. CPC A01K 87/04; B21D 22/02

(57) ABSTRACT

Embodiments are directed to rod tip guides. A rod tip guide may comprise a ring body, a rod tube, a foot, and a leg. The rod tube may be mechanically coupled to the ring body and configured to receive a tip end portion of a rod. The foot may be configured to be mechanically coupled to a circumferential surface of the rod when the tip end portion of the rod is received in the rod tube. The leg may have a proximal end portion and a distal end portion. The proximal end portion of the leg may be mechanically coupled to the ring body, the distal end portion of the leg may be mechanically coupled to the foot, and the leg may be configured to maintain a separation space between the rod tube and the foot when the tip end portion of the rod is received in the rod tube.

### TECHNICAL FIELD

The invention relates generally to rod tip guides and, more particularly, yet not exclusively, to rod tip guides in a fishing environment.

### BACKGROUND

Tip guides or tip-top guides for fishing rods typically have ring bodies, rod tubes, and legs. For a typical tip guide, a rod tube is disposed at a base of a ring body, and one or more legs extend from the ring body to a distal end portion of the rod tube. Typically, the one or more legs are welded to the rod tube. Although titanium is lighter weight than stainless steel, tip guides that are advertised as being titanium typically use stainless steel with a titanium coating for the frame of the rod tip. Welding titanium ring body and legs to a titanium rod tube can present challenges (for example, brittle welds, etc.). Further, stainless steel can be more susceptible to corrosion, rust, and stains than titanium. Moreover, a stainless-steel frame for the rod tip increases the weight of the tip guide. Thus, it is with regard to these considerations and others that the present invention has been made.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of the Various Embodiments, which is to be read in association with the accompanying drawings, wherein:

FIG. 1 illustrates a schematic side depiction of an example fishing rod having a tip end portion and an example tip guide disposed at the tip end portion of the rod;

FIG. 2 shows a schematic bottom view of the tip guide of FIG. 1 disposed at the tip end portion of the rod; and

FIG. 3 illustrates a schematic side view of the tip guide of FIG. 2 disposed at the tip end portion of the rod.

### DETAILED DESCRIPTION OF THE VARIOUS EMBODIMENTS

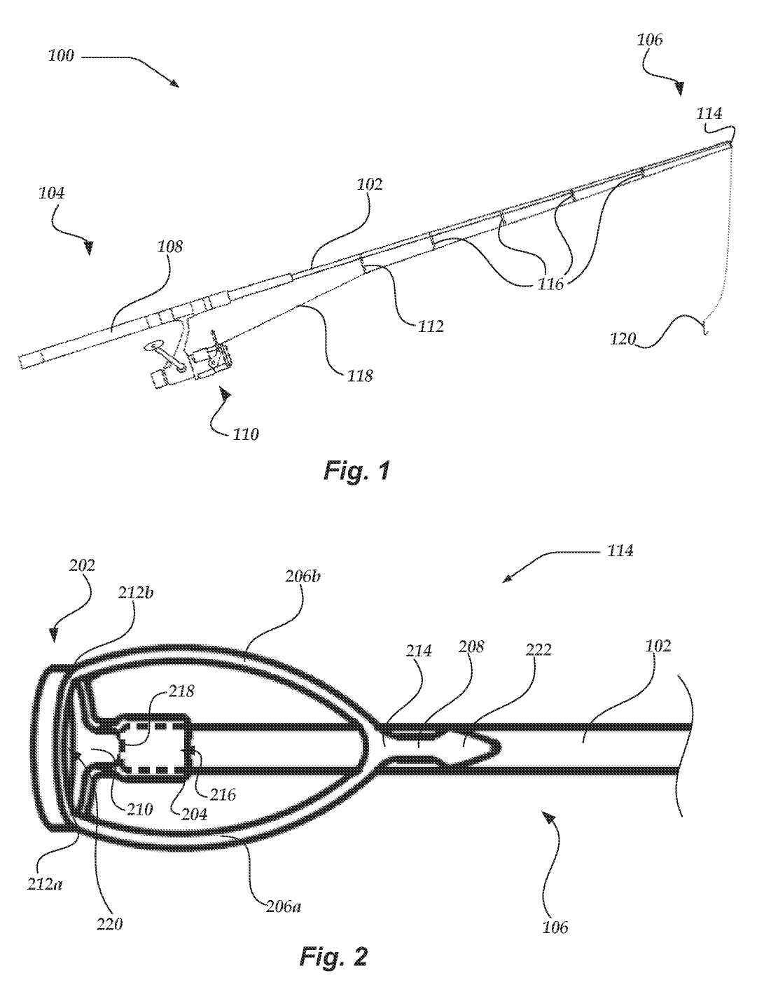

FIG. 1 illustrates example fishing rod 100. Rod 100 includes a blank 102 having butt end portion 104 and tip end portion or tip-top end portion 106. Handle 108 and reel 110 are disposed at butt end portion 104 of rod blank 102. Butt guide or stripper guide 112 is disposed on blank 102 between butt end portion 104 and tip end portion 106. Example tip guide or tip-top guide 114 is disposed on blank 102 at tip end portion 106. Multiple intermediate guides 116 are disposed on blank 102 between butt guide 112 and tip guide 114. In other examples, rod 100 includes more, fewer, or none of butt guide 112 or intermediate guides 116. Although FIG. 1 shows each of reel 110, butt guide 112, intermediate guides 116, and tip guide 114 as being disposed on the bottom side of blank 102, other examples of rod 100 include one or more of reel 110, butt guide 112, intermediate guides 116, or tip guide 114 being disposed at other circumferential positions on blank 102, such as on the left, right, or top side of blank 102. Fishing line 118 spans from reel 110 through butt guide 112, intermediate guides 116, and tip guide 114 to hook or lure 120. In other examples, rod 100 lacks reel 110, and line 118 may be mechanically coupled to blank 102. Hook 120 can be cast away from rod 100 or reeled toward rod 100 while fishing line 118 slides through butt guide 112, intermediate guides 116, and tip guide 114.

FIG. 2 shows a schematic bottom view of tip guide 114 of FIG. 1 disposed at tip end portion 106 of blank 102. As shown in FIG. 2, tip guide 114 includes ring body 202, rod tube 204, leg 206a, another leg 206b, and foot 208. In other examples, tip guide 114 includes more or fewer legs 206 (for example, three legs 106 or only one leg 206). Each of rod tube 204, legs 206, and foot 208 have respective proximal end portions and distal end portions. In the example of FIG. 2, ring body 202 includes base 210, shoulder 212a, and another shoulder 212b. Also in this example, the proximal end portion of rod tube 204 mechanically couples to base 210 of ring body 202, the proximal end portion of leg 206a mechanically couples to shoulder 212a of ring body 202, and the proximal end portion of leg 206b mechanically couples to shoulder 212b of ring body 202. In other examples, ring body 202 includes multiple bases 210 that mechanically couple to rod tube 204. In some examples, base 210 mechanically couples to an intermediate portion or the distal end portion of rod tube 204. In some examples, the proximal end portions of two or more legs 206 mechanically couple to the same shoulder 212. Although FIG. 2 shows shoulders 212 as being disposed on the left-side and right-side portions of ring body 202, shoulders 212 may be disposed at any position on ring body 202.

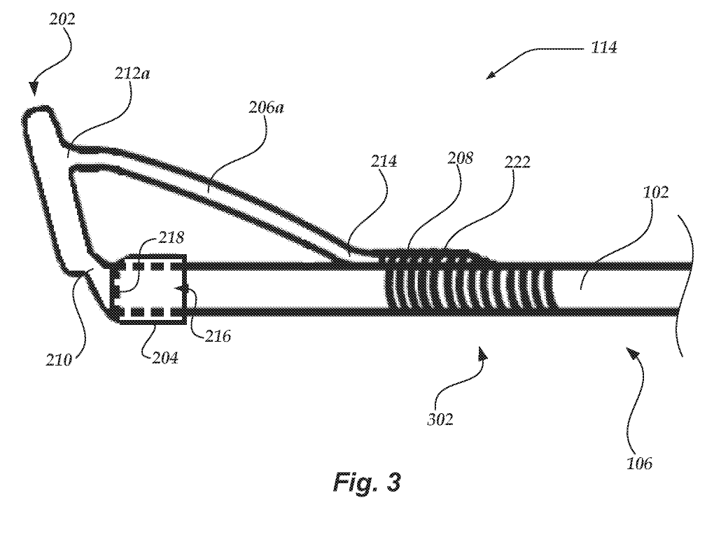

As also shown in FIG. 2, the distal end portions of legs 206a, 206b mechanically couple to each other to define heel 214. Foot 208 is configured to be mechanically coupled to a circumferential surface of blank 102 when tip end portion 106 is received in rod tube 204. For example, foot 208 may be sized, shaped, dimensioned, positioned, oriented, or otherwise arranged to be disposed on the circumferential surface of blank 102 when tip end portion 106 is received in rod tube 204 to facilitate mechanically coupling foot 208 to blank 102 (for example, mechanical coupling via threaded windings 302 in FIG. 3). In the example shown in FIG. 2, the proximal end portion of foot 208 mechanically couples to heel 214, with foot 208 being disposed opposite the distal end portions of legs 206 from rod tube 204. In other examples, the distal end portion of foot 208 extends distal to heel 214 while remaining spatially separated from rod tube 204. In some examples, each leg 206 has its own heel 214 that mechanically couples to foot 208 at a different position than each other heel 214. In other examples, tip guide 114 includes multiple feet 208, with each leg 206 mechanically coupling to a different foot 208.

The distal end portion of rod tube 204 has opening 216 that is configured (for example, sized, shaped, dimensioned, positioned, oriented, or otherwise configured) to receive tip end 218 of tip end portion 106 of blank 102. Each leg may be configured (for example, sized, shaped, dimensioned, positioned, oriented, or otherwise configured) to maintain a separation space that does not overlap any portion of tip guide 100 between rod tube 204 and foot 208. For example, prior to insertion (or after removal) of tip end 218 of blank 102 into opening 216 of rod tube 204, the separation space that does not overlap any portion of tip guide 114 includes external environment fluid, such as air. In the example shown in FIG. 2, when tip end 218 of blank 102 is received in rod tube 204, the separation space that does not overlap any portion of tip guide 114 includes a portion of blank 202 that is disposed between the distal end portion of rod tube 204 and proximal end portion of heel 214. Accordingly, each portion of each leg 206, heel 214, and foot 208 are positioned to avoid contact with rod tube 204.

Because the entirety of each leg 206, heel 214, and foot 208 is spatially separated from rod tube 204, rod tube 204 and foot 208 can be separately and distinctly secured to blank 102 to provide rigidity to tip guide 114 (see FIG. 3). Moreover, because rod tube 204 does not need to extend to the distal end portion of each leg 206, rod tube 204 can have a short length. A short length for rod tube 204 can reduce weight or costs when manufacturing rod tube 204 from a given material (for example, titanium) in comparison to using more of the given material in a longer length rod tube that extends to the distal end portion of legs 206. A short length for rod tube 204 can additionally facilitate easier manufacture by stamping, without welding a separate rod tube to ring body 202, legs 206, or foot 208. In contrast, a typical tip guide relies on welding of a separately machined or otherwise separately formed rod tube to its ring body and to one or more of its legs, heels, or feet to provide rigidity. However, welding any titanium portions of the typical tip guide (for example, ring body and legs, heels, or feet) to the rod tube can result in brittle welds or other challenges. Accordingly, by spatially separating rod tube 204 from each leg 206, heel 214, and foot 208, tip guide 114 obviates a need to weld rod tube 204 to any portion of legs 206, heel 214, or foot 208.

As shown in FIG. 2, ring body 202 defines eye 220 to facilitate fishing line 118 sliding through ring body 202. Although FIG. 2 shows ring body 202 as having a circular shape, ring body 202 may have any shape suitable to facilitate fishing line 118 guidably sliding through ring body 202 (for example, ovular, polygonal, or another shape). In other examples, ring body 202 defines multiple eyes 220 (for example, an eye within eye 220 or offset from eye 220, similar to guides available under the mark MicroWave™ from the American Tackle Company).

In some examples, foot 208 includes one or more toes 222. In the example shown in FIG. 2, toe 222 of foot 208 has an arrowhead shape to facilitate maintaining the position of tip guide 114 relative to blank 102 when secured to blank 102 (see, for example, FIG. 3). For example, as shown in the side view of FIG. 3, after tip end 218 is received in rod tube 204, thread may be wrapped around foot 208, including toe 222, to facilitate securing tip guide 114 to blank 102 via threaded windings 302. In some examples, epoxy, ferrule cement, or another adhesive may be placed into opening 216 of rod tube 204 prior to inserting tip end 218 of blank 102 into rod tube 204 to additionally facilitate securing tip guide 114 to blank 102. Also in some examples, epoxy, ferrule cement, or another adhesive may be placed around threaded windings 302 to further facilitate securing tip guide 114 to blank 102.

In some examples, each element of tip guide 114 (such as each ring body 202, base 210, rod tube 204, shoulder 212, leg 206, heel 214, foot 208, and toe 222) may be integral to each other element of tip guide 114. For example, each element of tip guide 114 may be formed from a single piece of material, such as metal. In some examples, tip guide 114 may be formed via molding, stamping, or another machining process to form tip guide 114 as a single integral component that includes each element of tip guide 114 (such as each ring body 202, base 210, rod tube 204, shoulder 212, leg 206, heel 214, foot 208, and toe 222).

Some examples of making tip guide 114 as a single integral component include stamping the entirety of tip guide 114 from only a single piece of material, such as a single sheet of titanium. Each element of tip guide 114 (such as each ring body 202, base 210, rod tube 204, shoulder 212, leg 206, heel 214, foot 208, and toe 222) may be formed from the single piece of material by one or more of piercing, cutting, punching, embossing, squeezing, bending, stretching, or another act of stamping. In some examples, each element of tip guide 114 may be integral to one or more other elements of tip guide 114 (for example, the single piece of material may not be severed between two elements and may instead be continuous in and between each element of tip guide 114, as shown in FIG. 2). Accordingly, the entirety of tip guide 114 may be stamped as a single integral component without welding.

Tip guide 114 can include titanium, aluminum oxide, aluminum alloy, stainless steel, shape-memory alloy (for example, nickel-titanium), Alconite, graphite, silicon carbide, titanium carbide, or another material. In some examples, tip guide 114 may be coated, such as coated with a layer of physical vapor deposition (PVD) to facilitate smoothness and durability. Tip guide 114 may include optional ceramic, porcelain, agate, or metal-alloy (for example, silicon carbide (SiC), Alconite, or others) ring inserts disposed in eye 220. Tip guide 114 may include different materials, sizes, shapes, dimensions, or other characteristics suitable for different types applications or different types of line 118. For example, when made for saltwater fishing where line 118 may have knots that need to pass through ring body 202, tip guide 114 may have a larger eye than, for example, when made for fly fishing in freshwater.

Although tip guide 114 has been explained with regard to a fishing environment (specifically in use with blank 102 of fishing rod 100), tip guide 114 may be used in any environment where a line slidably extends from or retracts toward a tip end portion of a rod that has been received in tip tube 204.

The various embodiments have been described above with reference to the accompanying drawings, which form a part hereof, and which show, by way of illustration, specific example embodiments by which the invention may be practiced. The embodiments may, however, be embodied in many different forms and should not be construed as limited to the examples set forth herein; rather, these examples are provided so that this disclosure will be thorough and complete and will fully convey the scope of the embodiments to those skilled in the art. Among other things, the various embodiments may be methods, systems, or devices. The following detailed description is, therefore, not to be taken in a limiting sense.

Throughout the specification and claims, the following terms take the meanings explicitly associated herein, unless the context clearly dictates otherwise. The phrase “in one embodiment,” “in one example,” or “in one implementation” as used herein does not necessarily refer to the same embodiment, example, or implementation, though it may. Furthermore, the phrase “in another embodiment,” “in another example,” or “in another implementation” as used herein does not necessarily refer to a different embodiment, example, or implementation, although it may. Thus, as described throughout, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, the meaning of “a,” “an,” and “the” include plural references. Further, plural references should be interpreted as also disclosing singular references. The meaning of “in” includes “in” and “on.” Also, the use of “when” and “responsive to” do not imply that associated resultant actions are required to occur immediately or within a particular time period. Instead, they are used herein to indicate actions that may occur or be performed in response to one or more conditions being met, unless the context clearly dictates otherwise. Additionally, throughout the specification, the use of “exemplary” does not imply that other embodiments do not perform as well or are not as worthy of illustration. Instead, the term is used herein to emphasize that each element or function described by the term is an example element or function. Further, the terms “proximal,” “distal,” and the like are used consistently with respect to all elements of tip guide 114 and fishing rod 100. The terms “proximal,” “distal,” and the like are defined relative to the distal end portion of rod tube 204.

The foregoing examples should not be construed as limiting or exhaustive, yet rather, illustrative use cases to show implementations of at least one of the various embodiments of the invention. Accordingly, many changes can be made without departing from the spirit and scope of the invention. Thus, the scope of the invention is not limited by the disclosure of the examples. Instead, the invention should be determined entirely by reference to the claims that follow.

The embodiments of the invention in which an exclusive property or privilege is claimed are defined as follows:

1. A rod tip guide comprising:
a ring body, the ring body defining an eye;
a rod tube mechanically coupled to the ring body, the rod tube being configured to receive a tip end portion of a rod;
a foot configured to be mechanically coupled to a circumferential surface of the rod when the tip end portion of the rod is received in the rod tube; and
a leg, the leg having a proximal end portion and a distal end portion, the proximal end portion of the leg being mechanically coupled to the ring body, the distal end portion of the leg being mechanically coupled to the foot, and the leg being configured to maintain a separation space between the rod tube and the foot when the tip end portion of the rod is received in the rod tube.

2. The rod tip guide of claim 1, wherein the foot and the rod tube each include a same material.

3. The rod tip guide of claim 1, wherein the foot and the rod tube each include titanium.

4. The rod tip guide of claim 1, wherein the ring body, the rod tube, the leg, and the foot each include a same material.

5. The rod tip guide of claim 1, wherein the foot is integral to the leg, the leg is integral to the ring body, and the rod tube is integral to the ring body.

6. The rod tip guide of claim 1, further comprising another leg having a proximal end portion and a distal end portion, the proximal end portion of the other leg being mechanically coupled to the ring body, the distal end portion of the other leg being mechanically coupled to the foot, and the other leg being configured to maintain the separation space between the rod tube and the foot when the tip end portion of the rod is received in the rod tube.

7. The rod tip guide of claim 1, wherein the foot is disposed opposite the distal end portion of the leg from the rod tube.

8. The rod tip guide of claim 1, wherein the rod tube extends from the ring body toward the distal end portion of the leg, and the leg is configured to maintain a separation space between the rod tube and the leg.

9. The rod tip guide of claim 1, wherein the foot includes a toe that has an arrowhead shape.

10. The rod tip guide of claim 1, wherein the eye is configured to receive a fishing line when the tip end portion of the rod is received in the rod tube.

11. A method of making a rod tip guide, the method comprising:
providing a piece of material;
stamping a ring body in the piece of material, the ring body defining an eye;
stamping a rod tube in the piece of material, the rod tube being mechanically coupled to the ring body, the rod tube being configured to receive a tip end portion of a rod;
stamping a foot in the piece of material, the foot being configured to be mechanically coupled to a circumferential surface of the rod when the tip end portion of the rod is received in the rod tube; and
stamping a leg in the piece of material, the leg having a proximal end portion and a distal end portion, the proximal end portion of the leg being mechanically coupled to the ring body, the distal end portion of the leg being mechanically coupled to the foot, and the leg being configured to maintain a separation space between the rod tube and the foot when the tip end portion of the rod is received in the rod tube.

12. The method of claim 11, wherein each act of stamping includes one or more of piercing, cutting, punching, embossing, squeezing, bending, or stretching.

13. The method of claim 11, wherein the piece of material is a piece of titanium.

14. The method of claim 11, wherein the piece of material is continuous between the ring body and the rod tube, between the ring body and the leg, and between the leg and the foot.

15. The method of claim 11, wherein the foot is integral to the leg, the leg is integral to the ring body, and the rod tube is integral to the ring body.

16. The method of claim 11, further comprising stamping another leg in the piece of material, the other leg having a proximal end portion and a distal end portion, the proximal end portion of the other leg being mechanically coupled to the ring body, the distal end portion of the other leg being mechanically coupled to the foot, and the other leg being configured to maintain the separation space between the rod tube and the foot when the tip end portion of the rod is received in the rod tube.

17. The method of claim 11, wherein the foot is disposed opposite the distal end portion of the leg from the rod tube.

18. The method of claim 11, wherein the rod tube extends from the ring body toward the distal end portion of the leg, and the leg is configured to maintain a separation space between the rod tube and the leg.

19. The method of claim 11, wherein the foot includes a toe that has an arrowhead shape.

20. The method of claim 11, wherein the eye is configured to receive a fishing line when the tip end portion of the rod is received in the rod tube.
